(19) United States
(12) Patent Application Publication
(10) Pub. No.: US 2018/0243781 A1
(43) Pub. Date: Aug. 30, 2018

(54) PRODUCTION SYSTEM AND METHOD FOR PRODUCING MOTOR VEHICLE LICENSE PLATES

(71) Applicant: ERICH UTSCH AG, Siegen (DE)

(72) Inventors: Jochen BUERGER, Mudersbach (DE); Thomas WOLLENWEBER, Siegen (DE); Christoph WAESCHENBACH, Kirchen (DE); Bernd PFUNDSTEIN, Ehringhausen (DE); Harald Klaus Ludwig BRUCH, Freudenberg (DE); Holger REEH, Siegen (DE)

(21) Appl. No.: 15/754,527

(22) PCT Filed: Aug. 16, 2016
(86) PCT No.: PCT/EP2016/069390

§ 371 Date: Feb. 22, 2018

(30) Foreign Application Priority Data
Sep. 1, 2015 (DE) 10 2015 114 573.1

(51) Int. Cl. B05C 1/02; B05C 1/14; B44B 5/02; B21D 22/02; B44C 3/08; B44B 5/00

(52) U.S. Cl. CPC B05C 1/027; B05C 1/14; B44B 5/022; G09F 7/00; B44C 3/085; B44B 5/009; B21D 22/022

(57) ABSTRACT

A production facility for manufacturing motor vehicle license plates includes a hot stamping machine configured for the continuous application of ink to stamped plates by hot stamping. At least one first conveying component is provided to transport stamped plates through the hot stamping machine. The production facility includes at least one transfer arrangement having a buffer with a cashing component for at least two flat objects wherein the production facility includes a control unit for controlling the buffer for a successive deposition of flat objects from the buffer onto the first conveying component. In particular, with such a buffer, stamped plates and/or templates can be deposited on the first conveying component. The disclosure also relates to a process for operating such a production facility.

### TECHNICAL FIELD

The disclosure relates to a production facility for manufacturing motor vehicle license plates comprising a hot stamping machine that continuously applies ink to stamped license plates by means of hot stamping. At least one conveying means is provided for transporting stamped license plates through the hot stamping machine. The disclosure also relates to a process for operating such a production facility.

### BACKGROUND

In manufacturing stamped plates, in particular motor vehicle license plates, it is know to feed stamped license plates to a hot stamping machine. In the stamped license plates, a certain combination of letters and/or numbers is stamped out to appear raised on the front side of the plate. This combination of letters and/or numbers is also called the legend. In the hot stamping machine, the raised stamped out legend and often also a surrounding frame are tinted in ink. This tinting can be done by using a plastic hot stamping foil that serves as the carrier element for a hot removable ink. The stamped plate is placed on a work table or conveyor belt such that the visible side with the raised legend is on top. Then the plate is moved underneath a hot stamping foil which is typically pressed against the plate by a heated pinch roller such that the hot ink is applied by the foil to the raised parts of the plate. When this process is done continuously for multiple plates, it can be provided that new hot stamping foil is continuously unrolled from a supply spool and pressed by the pinch roller to a plate being passed underneath. Subsequently, the used foil wraps around a collector spool. For example, such a hot stamping machine is described in DE 37 41 232 A1.

It must be taken into consideration that sections of the hot stamping foil unrolled at one point in time when no plate is underneath a pinch roller are wrapped unused around the second collector spool and are then discarded. This should be avoided for environmental reasons as well as to save costa. Therefore, to have as little unused hot stamping foil as possible, the plates should be passed through the pinch roller with the smallest possible spacing between each other. Under this aspect, it should also be avoided to stop the hot stamping machine unnecessarily, since unused hot stamping foil can hardly be avoided when the machine has to be started up again.

The stamped plates can come from various sources. For example, they can be manually placed onto the conveying means to be taken to the hot stamping machine, or come directly from an automatic stamping press which places the plates on the conveying means. It is very difficult to constantly maintain a small spacing between plates on the conveying means.

It can also become necessary not only to continuously take stamped plates to a hot stamping machine, but also templates which are laid onto the plates and moved through the hot stamping machine together with the plates. Such templates are used to only partly print the raised sections of stamped plates. This may become necessary, for example, when a plate must be printed in different colours. In that case, a template is laid on a stamped plate that has gaps where a first colour is to be printed onto the plate. Other sections are first covered by the template. For applying the second colour, other sections are either left out or covered with another template in another pass.

Such templates can also be placed manually on plates that are transported to the hot stamping machine on a conveying means. However, it is more advantageous to deposit the templates automatically.

### SUMMARY

The disclosure therefore provides an improved production facility for manufacturing motor vehicle license plates with a hot stamping machine with which in particular the above named requirements can be met.

According to the disclosure, this object is achieved with a production facility for manufacturing motor vehicle license plates according to the preamble of Claim 1. Advantageous embodiments of the facility result from sub-Claims 2-15. The object is also achieved with a process for operating such a production facility according to independent Claim 16. Advantageous embodiments of the process result from Claims 17-25.

It should be pointed out that the individual characteristics can also be combined in any technically reasonable manner to show further embodiments of the disclosure. The description additionally characterizes and specifies the disclosure in particular with reference to the Figures.

The inventive production facility serves to manufacture motor vehicle license plates and comprises a hot stamping machine designed for the continuous application of ink to stamped license plates by means of hot stamping. This involves at least one first conveying means to transport stamped plates through the hot stamping machine. For example, this conveying means can be a powered conveyor belt. In connection with the hot stamping machine, “continuously” means that during operation, stamped license plates are constantly fed to the hot stamping machine and that these are fed through the hot stamping machine. As the plates run through the hot stamping machine, ink is applied to the plates by means of hot stamping such that a continuous flow of motor vehicle license plates is leaving the hot stamping machine.

According to the disclosure, the production facility also comprises a transfer arrangement comprising a buffer with means to cache at least two flat objects, and comprises a control unit designed to control the buffer for a successive transfer of flat objects from the buffer onto the first conveying means.

The flat objects can be various kinds of objects. For example, they can be templates that can be laid on stamped license plates situated on the first transport means and which can be transported together with the templates through the hot stamping machine.

With this application, the inventive transfer arrangement can be advantageously used to deposit templates on stamped license plates in a controlled and regulated manner which are on a conveyor and are transported from those to a hot stamping machine. Therefore, this process must no longer be performed manually. For depositing a template in a certain way, the facility can comprise a sensor means. This sensor means is designed to detect the position of stamped license plates on the first transport means. Thus, the sensor means detects where a stamped license plate is on the conveyor such that the buffer can deposit a template on the license plate at the correct point in time.

Preferably, such templates can be used multiple times such that an embodiment of the disclosure provides that the transfer arrangement comprises means to lift the templates from printed motor vehicle license plates behind the hot stamping machine and to move these templates into the buffer of the transfer means. Thus, templates can be moved back to the buffer after their use and be deposited onto another license plate.

However, in a particularly advantageous embodiment of the disclosure, the flat objects are stamped license plates that can be deposited from the buffer onto the conveying means and thus transported through the hot stamping machine. In this case, the license plates are not randomly taken to the hot stamping machine, but they can be deposited by the control unit from the buffer onto the first conveying means in a controlled manner. In particular, it is possible that way for the control unit to deposit the license plates in predetermined spacings from the buffer onto the first conveying means and thus to the hot stamping machine. With the smallest possible spacing between the plates, the number of unused hot stamping foils can be considerably reduced in comparison with previous solutions.

The stamped license plates can previously have been conveyed to the buffer of the transfer arrangement in different ways. For example, they can be taken to the buffer manually by a person who deposits stamped plates into the transfer arrangement individually or in stacks. Stamped plates can also drop in succession from an automatic stamping press into the transfer arrangement to be systematically deposited by the control unit of the transfer arrangement onto the first conveying means and thus conveyed to the hot stamping machine. In both cases, stamped plates can be conveyed to the transfer arrangement in irregular spacings, which however can be equalized by caching them in the buffer, such that the plates are taken to the hot stamping machine in regular spacings. Thus, the disclosure can be applied in all situations in which stamped plates are not to be taken to a hot stamping machine haphazardly, but in a systematic manner and especially in defined spacings between them.

The transfer arrangement has special advantages when applied between a hot stamping machine and an automatic stamping press designed for the continuous production of stamped plate. “Continuously” in connection with the stamping press means that the press stamps the plates continuously during operation and discharges them in succession. This results in a continuous output of stamped plates wherein the spacing between these plates can vary, and gaps can occur, for example due to a stack change when plate blanks are introduced in the stamping press.

The stamping press has information about a large number of legends to be stamped, and the automatic stamping press is supplied with plate blanks for each stamping of a certain legend. Typically, the plate blanks are made of sheet aluminum in which, for example, a raised surrounding frame has already been stamped. Also, a reflective plastic foil has already been applied to the plates. For example, these prefabricated blanks are continuously fed to the stamping press from a stack, and in succession a certain legend is stamped into each blank by changing the stamping tools.

Thus, the stamped plates are continuously leaving the automatic stamping press to be subsequently taken to a hot stamping machine which provides the raised regions of each plate with ink from a hot stamping foil. This transport connection between the automatic stamping press and the hot stamping machine can be direct, wherein stamped plates are laid onto a conveyor belt which is also the conveyor belt for taking plates to the hot stamping machine. Alternatively in one place the stamped plates can also be continuously transferred from a first conveyor belt at the output of the stamping press to a second conveyor belt at the input of the hot stamping machine. In both cases however, the working speed of the hot stamping machine should be adapted as closely as possible to the working speed of the upstream stamping press or vice versa, to ensure a continuous and trouble-free operation. However, this synchronization of the two machines is very difficult and can cause problems especially when one of the machines has a malfunction.

The optimal working speeds of both machines are often different which means that a synchronization can have detrimental consequences at least with one of the machines. For example, if hot stamping proceeds at a speed of about 6 m/min, the speed regulation of the stamping machine can require special dexterity and constant observation of the process. The main danger is that two stamped plates run above each other and into the hot stamping machine together, which can damage the pinch roller. However, it can also cause a backup ahead of the hot stamping machine, affecting the stamping press as well.

The plate blanks are also taken to an automatic stamping press, typically in stacks with a certain number of blanks. When the stacks are being changed, there may be a temporary delay in the output of stamped plates at the stamping press. The speed of the hot stamping machine has to be exactly matched to this.

However, with the transfer arrangement according to the inventive production facility, the processes between the hot stamping machine and the automatic stamping press can be designed such that the above disadvantages are avoided.

Between the stamping press and the hot stamping machine, at least one second conveying means for the removal of the stamped plates from the stamping press can be provided. This second conveying means can also comprise a powered conveyor belt. In that case, the transfer arrangement is provided between the two conveying means, wherein the plate stamped with the transfer arrangement can continuously be transferred to the first conveying means, and the control unit is designed to control the buffer to remove the plates in succession from the buffer to the first conveying means.

In this manner, the plates are conveyed from the automatic stamping press through the hot stamping machine. It can be provided that there is no direct conveying connection between the two machines, but that there is an intermediate transfer between various conveying means or conveyor belts. In that case, the special advantage is that the two machines and the conveyor belt can be operated separately from each other.

However, in one embodiment of the disclosure, the first and the second conveying means are formed by a continuous conveyor belt, temporarily picked up by the plate and laid on the conveyor belt again. According to the disclosure, the first and the second conveying means can also be formed by a single conveying means with two sections before and behind the transfer arrangement.

Preferably, the control unit is designed in accordance with the activation of the buffer. The spacing between the plates on the first conveying means can be selected such that there is as little unused hot stamping foil as possible between the plates. Regardless of the spacing between the stamped plates, when they leave the stamping press, plates stamped that way can be conveyed to the hot stamping machine with the smallest possible spacing between each other. The speed of the first conveying means, with which the plates are transported through the hot stamping machine, can also be suitably selected without this speed having to exactly match the speed of the second conveying means and vice versa. Instead, the buffer allows the caching of plates if for example the second conveying means transports faster to the buffer than the first conveying means removes the plates. Thus, a backup of stamped plates in front of the hot stamping machine can be avoided.

Delays in the output of stamped plates by the stamping press can also be compensated for by the buffer. For example, when a stack of blank plates is exchanged for stamping in the stamping press, this leads to a small delay in the output of stamped plates. However, this must not be detected, for example, to temporarily reduce the speed of the conveying means of the hot stamping machine. Instead, plates can continue to be discharged from the buffer continuously. Only when the buffer is empty can it happen that the first conveying means is stopped.

The output of plates from the hot stamping machine can be chosen to be slightly slower than the output from the stamping press. In this way, the buffer would overflow after a certain time. However, since there is a delay at regular spacings when the stack in the stamping press is changed, the speed and the capacity of the buffer can be selected such that the buffer fills up between the changes of stacks and can empty while the stack is being changed.

But even other operational irregularities during the output of stamped plates by the stamping press can be compensated for by the buffer. Since every plate is given an individual legend, each necessary alignment of the stamping tools can take a different amount of time. That is why the spacing between plates constantly leaving the stamping press can vary slightly, but this can also be compensated for by the buffer of the transfer arrangement.

Altogether it is possible with the inventive buffer for caching the plates that stamped plates are fed to a hot stamping machine at a constant speed and at predetermined spacings, regardless of how quickly an automatic stamping press or another source may discharge the stamped plates. In this manner, this spacing between the plates in the hot stamping machine can be set to be small enough, so that the volume of unused hot stamping foil is very low. For example, spacings of about 5 mm can be achieved. This reduces production costs and is also an environmental advantage. Malfunctions such as plates overlapping each other when entering the hot stamping machine and/or the backup of plates back into a stamping press can be avoided. Furthermore, no intensive supervision is necessary for the operation of the two machines since minor malfunctions are largely compensated for by the buffer. Thus, the disclosure is also beneficial for the stability of the overall process.

The buffer can have a variety of designs. In one embodiment of the disclosure, the buffer is provided with at least two deposition levels with appropriate holding means for holding flat objects at those depositional levels. In that case, the control unit is designed to control these holding means such that flat objects are held at the appropriate levels or are released from a certain level. In particular, they can be released by making them fall down from a level. When an object is brought into the buffer, it is first cached at a deposition level where it is held at this level by the holding means. For instance when this object is to be moved to another level or discharged completely from the buffer, the holding means are controlled such by the control unit that the object drops from that level. This way, the object can be moved to a next level, wherein for example at least two deposition levels can be arranged above each other. When one object drops from a first level, it thus drops onto a level below where it is again held by other holding means. From the lowest plane, it can be dropped onto the second conveyor belt.

In one embodiment of the disclosure, the buffer has three deposition levels. At least two deposition levels are required for objects to be discharged from the buffer at a short spacing. At least three deposition levels have proven advantageous to be able to always take objects to an upper deposition level of the buffer while discharging objects from the lower levels. When the control unit releases the lowest deposition level to deposit an object on the first conveying means, the buffer is controlled such that an object can now drop from the middle deposition level to the lowest deposition level that has now become available. Then the object can drop from the highest deposition level to the middle deposition level such that a new object can be deposited at the highest deposition level. Thus the objects pass several levels of the buffer until they are automatically deposited on the first conveying means. A larger number of deposition levels can also be provided such that the described process can also be transferred to more than three deposition levels/steps.

It is always most practical when the buffer is filled from the top and the objects drop in succession through all steps until they are handed over at the lowest deposition level to the first conveying means. Preferably therefore the first conveying means runs below the buffer such that objects drop from the buffer to the first conveying means. However, supplementary transfer mechanisms can be provided with which objects are deposited on the first conveying means. For example, an object can also be laid by a gripper from the lowest level to the first conveying means, and/or slanted ramps can be used.

The holding means of a deposition level can also be of various designs. For example, it can comprise at least two opposite support elements which can be moved by the control unit between at least two positions. In a first position, an object is held by the support elements while in a second position it is not held by them. For example, in this embodiment of the disclosure it can be provided that the spacing between the support elements in a first position is smaller than width B of the object while the spacing between the support elements in a second position is greater than width B of the object. Thus the objects are in the buffer such that their longer lateral edges can be supported on the support elements that lie opposite them. When the support elements are pulled back from the control unit, the objects drop between the support elements.

However, other embodiments of buffers or support elements can be used as well. For example, objects could also be cached side by side and moved in succession through several adjacent levels. The facility can also be adapted to objects of various size. For example, the spacing between holding means can be adaptable such that objects of various dimensions can be held in the buffer or drop from the buffer.

To transfer plates from the second conveying means to the buffer, the transfer arrangement can be provided with a gripper device. For example, this can be a suction gripper, whose one or more suction cups are respectively controlled by the control unit to lift an object from the second conveying means and to transfer it into the buffer.

Also covered by the disclosure is a process for operating a production facility according to an embodiment of the disclosure in which flat objects are continuously deposited in succession by the transfer arrangement from the buffer onto the first conveying means. For example, plates can be taken continuously by the transfer arrangement from the first conveying means into the buffer, and the control unit can control the buffer such that plates are in succession taken from the buffer at a predetermined spacing X and deposited on a second conveying means. This process has the above mentioned advantages.

Also covered by the disclosure is a process for operating a production facility according to an embodiment of the disclosure where plates are continuously taken in succession from the buffer from the transfer arrangement continuously at a predetermined spacing X and deposited on the first conveying means. This process has the above mentioned advantages.

In one embodiment of the disclosure, spacing X between the plates on the first conveying means is smaller than spacing Y between the plates on the second conveying means. The spacing between the plates is thus reduced by the buffer to ensure that as little used hot stamping foil as possible is produced in the hot stamping machine. For example, spacing X can be in the magnitude of 3 mm to 20 mm, especially between 3 mm and 10 mm, and preferably at about 5 mm. 5 mm has proven to be the spacing at which the stamped plates can be taken safely through the hot stamping machine such that only a minor amount of unused hot stamping foil is left over. This is a considerable saving of hot stamping foil in comparison with conventional operational processes in such production facilities.

On the other hand, spacing Y on the second conveying means can be at least 20 mm, preferably about 50 mm. For example, a spacing Y of approximately 50 mm has proven advantageous; it allows enough time and space to transfer plates with a gripper from the second conveying means into the buffer.

However, the crucial factor is not only the spacing between the plates, but also the speed of the two conveying means. For example, the first conveying means of the hot stamping machine is operated at 6 m/min, and the speed of the second conveying means of the stamping press is suitably adapted to this. Its speed can also be 6 m/min. When the two conveying means are formed by a common conveyor belt, the speed is constant at any rate.

When a buffer is used that is provided with at least two deposition levels above each other, each with a holding means for holding and detaching objects at those deposition levels, the process may provide for the control unit to control the buffer such that an object drops from a first deposition level whereupon another object drops directly from the second deposition level onto the now vacant first deposition level. Thus, objects can be moved in succession from the top through the buffer to be cached until an object from the lowest deposition level is transferred to the second conveying means.

The control unit can also be in connection with the hot stamping machine and control it such that it stops when there is no object in the buffer. This happens for example when a malfunction prevents the transfer of stamped plates to the buffer for a long time. The stamping machine can stop immediately wherein plates can still be on the conveying means between the buffer and the hot stamping machine. It can be provided that a plate in the hot stamping machine is still printed before the machine and the first conveying means stop printing the next plate. When the hot stamping machine starts up again, the plates remaining on the first conveying means can be printed. Alternatively it can also be provided that the hot stamping machine and the first conveying means are stopped only when all plates on the first conveying means have run through the hot stamping machine.

When the buffer is used for other flat objects such as templates, the transfer arrangement continuously deposits these templates from the buffer onto stamped plates on the first conveying means. It can be provided that the transfer arrangement deposits a template on a stamped plate on the first conveying means as soon as a sensor means detects the presence of a stamped plate in a predetermined position on the conveying means.

### BRIEF DESCRIPTION OF THE DRAWINGS

Other advantages, specialties and practical further developments of the disclosure result from the following description of preferred embodiments with reference to the drawings, where

FIG. 1 shows a schematic view of a first embodiment of an inventive production facility for manufacturing motor vehicle license plates;

FIG. 2 shows a transfer arrangement with buffer in a first three-dimensional view;

FIG. 3 shows a transfer arrangement according to FIG. 2 in a second three-dimensional view;

FIG. 4 shows a buffer of the transfer arrangement in four different states (a)-(d); and

FIG. 5 shows a schematic view of a second embodiment of an inventive production facility for manufacturing motor vehicle license plates.

### DETAILED DESCRIPTION OF THE DRAWINGS

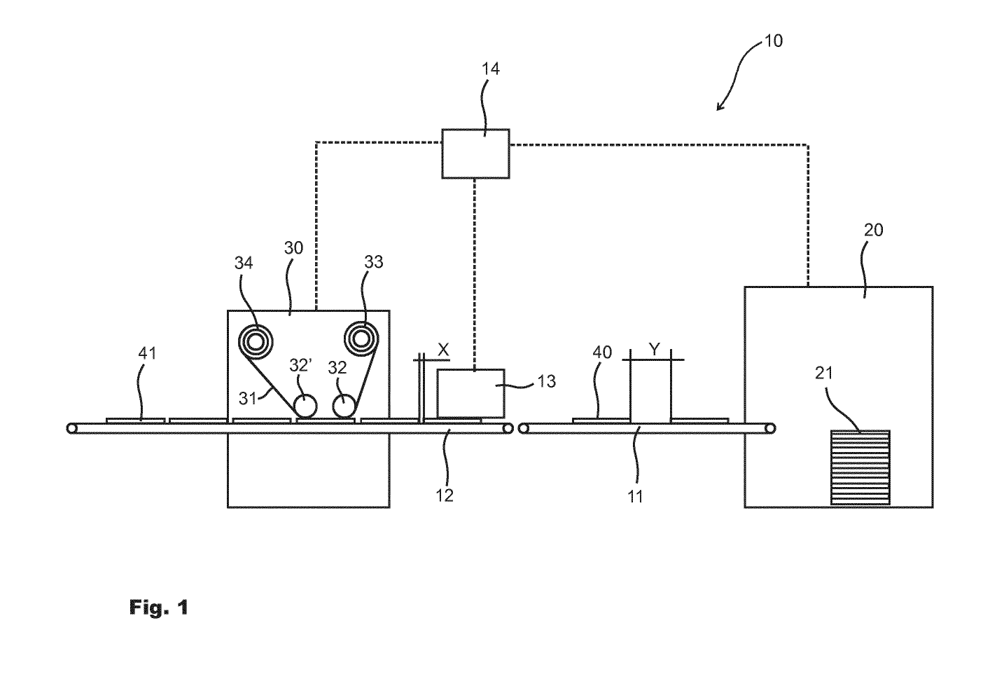

FIG. 1 shows a schematic view of a first embodiment of an inventive production facility 10 for manufacturing motor vehicle license plates 40. This comprises an automatic stamping press 20 and a hot stamping machine 30, which can be designed in a conventional manner and whose construction does not have to be described in detail for this disclosure. In general, the stamping press 20 is designed to process continuously fed plate blanks by providing them with a stamping. For example, these comprise a surrounding and a legend which are stamped to appear raised. For this purpose, the stamping press 20 is continuously supplied with blanks, which can be done for example with a stack 21 of blanks which are in succession stamped by the stamping press 20. Each plate is provided with an individual legend that can be given to the stamping press by a computer control. Thus, when the press 20 is in operation, continuously stamped plates 40 are discharged by the press and deposited onto a conveying means 11. Preferably, this conveying means 11 is a conveyor belt, for example in the shape of a conveyor belt.

The hot stamping machine 30 is designed to print these stamped plates 40 by means of hot stamping to produce motor vehicle license plates 41 from them. At high temperature, ink is applied to the raised portions of the plates. The plates 40 are continuously fed to the hot stamping machine 30 via a conveying means 12, and this conveying means 12 also moves them through the hot stamping machine 30. This conveying means 12 can also be a belt conveyor.

The hot stamping machine 30 can be designed in various ways to continuously apply ink to the continuous stream of plates 40. It has proven to be advantageous to use one or more heatable pinch rollers with which the plates 40 are printed from above. In the embodiment of FIG. 1, a double-head hot stamping machine with two pinch rollers 32 and 32′ is used. Under these pinch rollers 32, 32′ runs a hot stamping foil 31, comprising plastic foil, which serves a carrier material for a hot-removable ink. When the hot stamping foil 32 is pressed under heat against the raised portions of a license plate 40, the ink comes off the foil, which prints the license plate. The hot stamping foil 31 continuously unwraps from a supply spool 33, and the used hot stamping foil wraps around a collector spool 34. Thus, foil 31 runs from the supply spool 33 under the pinch rollers 32, 32′ to the collector spool 34. Preferably, pinch rollers 32, 32′ are vertically movable such that can be raised and lowered. For example, they are raised when the hot stamping machine 30 is not in operation or when it is temporarily stopped.

Between the first conveying means 12 and the second conveying means 11 a transfer arrangement 13 is provided that is connected with a control unit 14. This control unit 14 is only shown schematically in FIG. 1 and can have any kind of arrangement. It can be integrated in the transfer arrangement 13 or provided as a remote control. It can also be a central control unit in connection with other components of the facility. In particular it can be connected for communication with the stamping press 20 and the hot stamping machine 30 as is provided in the embodiment of FIG. 1.

The transfer arrangement 13 is designed to transfer plates 40 from the conveying means 11 to the other conveying means 12 wherein the plates are temporarily cached in a buffer of the transfer arrangement. Control unit 14 in particular controls this buffer such that the plates are deposited in succession in a predetermined spacing X on conveying means 12. Typically, this spacing X differs from spacing Y of the plates 40 on conveying means 11. Preferably, spacing X is smaller than spacing Y, since it is desirable that the hot stamping machine 30 has the smallest possible spacing between plated 40. On the other hand, the spacing Y of the plates plate 40 on the conveying means 11 can be larger, for example to make the transfer from conveying means 11 into the buffer easier.

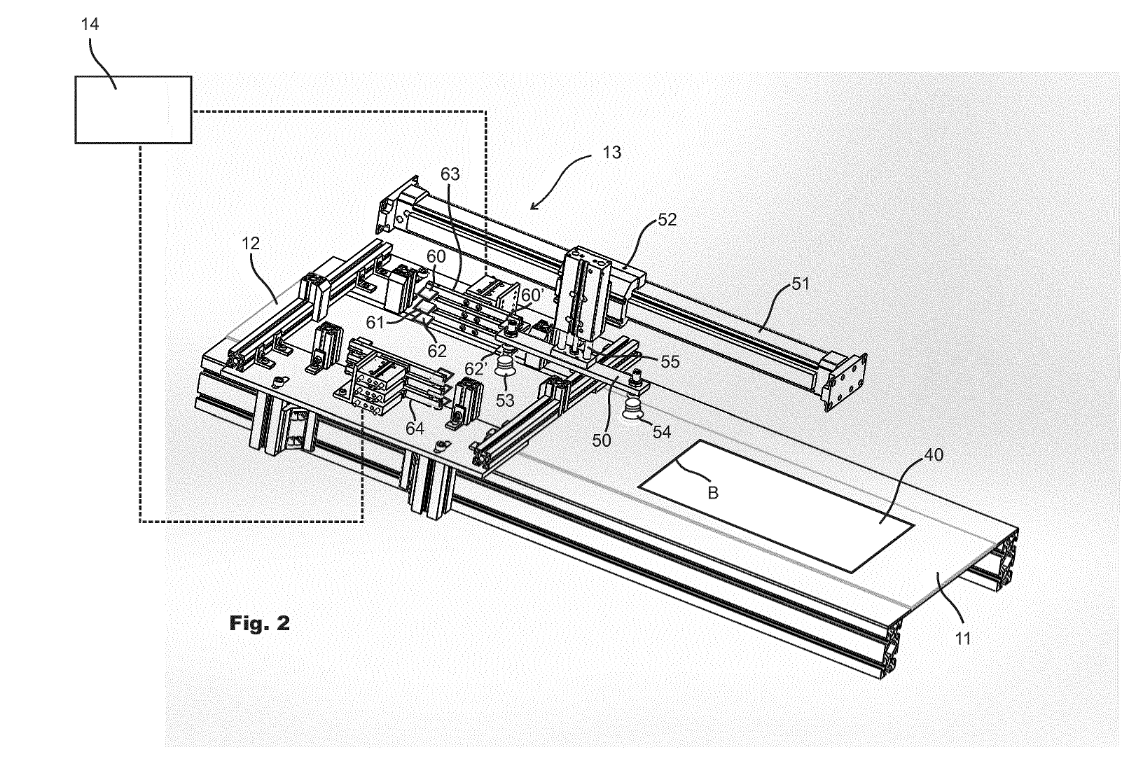

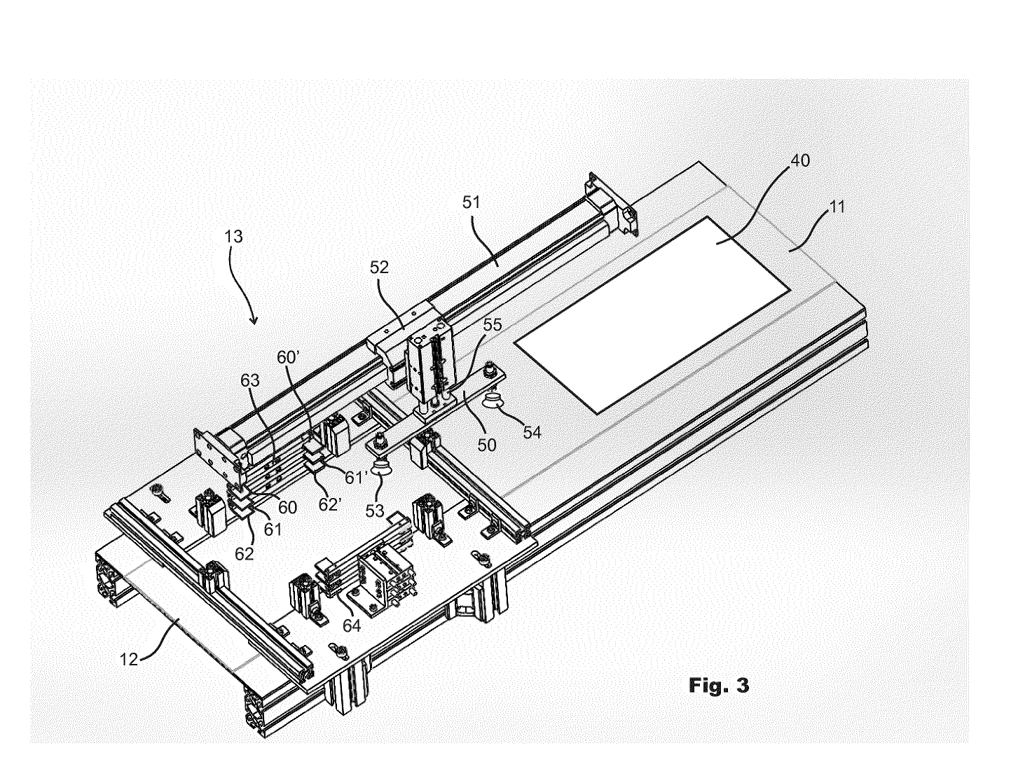

FIGS. 2 and 3 show a possible embodiment of such a transfer arrangement 13 with buffer. FIG. 2 shows a first three-dimensional view of a transfer arrangement 13 that is provided between two conveying means 11 and 12. With conveying means 11, plates 40 are transported to transfer arrangement 13 wherein for example, the plates 40 are transported lengthwise. Plates 40 have a width of B. Transfer arrangement 13 comprises a gripper device 50 with which the plates 40 can be raised by conveying means 11 and transferred to the buffer. This gripper device 50 can be formed by one or more suction grippers wherein for example two suction cups 53 and 54 are provided along an elongated connecting profile. These suction cups 53, 54 are in connection with tubes (not shown) for producing and relieving a negative pressure in the suction cups 53, 54. The suction gripper 50 thus formed is movable via a skid 52 along a rail 51. The direction of movement of the skid 52 is that of the first conveying means 11. Thus the suction gripper 50 can be moved with skid 52 into a position above a plate 40 where it can be lowered via a lifting device 55. Suction cups 53, 54 grip plate 40, the suction gripper 50 is raised and moved to the buffer along the conveying means 11.

The buffer is formed by at least two deposition levels which are shown above each other in the embodiment of FIGS. 2, 3 and 4. Here, three deposition levels were chosen. These deposition levels are formed by several holding means with which plates can be held at one level. For example, these are support elements at several levels. The support elements can be formed by small plates as shown in FIG. 2. Each deposition level is formed by four support elements, two of which are opposite each other such that one license plate can be deposited on them. Two of the small plates are always on a first support side 63 of the buffer, and two other small plates are on an opposite support side 64. The spacing between the small plates is selected accordingly.

FIG. 2 shows as an example three support elements above each other marked with reference numbers 60, 61 and 62. On the same support side 63 are three further support elements, the highest and lowest of which are visible and marked with reference numbers 60′ and 62′. The view in FIG. 3 shows all support elements 60, 61, 62 and 60′, 61′, 62′ on this support side 63. On the opposite support side 64 are another six support elements to form a total of three deposition levels above each other.

However, the support elements 60, 61, 62 and 60′, 61′, 62′ on one side can also be designed continuous such that they form three longer support webs. They can also be designed as pin-shaped support elements or as elements of different configuration.

The support elements are movable and can be controlled on both support sides 63, 64 by control unit 14 such that their position and thus the spacing between opposite support elements can be changed. In a first position, the spacing between opposite support elements is chosen such that a plate 40 can be deposited on the support elements. The spacing is thus smaller than the width B of plate 40. In a second position, the spacing is larger than the width B, such that a plate 40 is no longer held on the deposition level but drops down from it. For this, the support elements can be movable in horizontal direction. However, they can also be designed to tilt such that the can be tilted downward to enlarge the spacing. A combination of both movements is also possible.

Extending below the thus formed buffers is conveying means 12. If plates 40 drop down from the buffer, they will therefore drop onto conveying means 12 which will transport them to hot stamping machine 30. However, the two conveying means can also be formed by a single conveyor belt which extends underneath transfer arrangement 13.

The buffer is arranged such that plates can first be deposited with the suction gripper 50 to the highest deposition level of the buffer. Subsequently, the suction gripper 50 runs back along rail 51 and grips the next plate. For depositing a plate at the highest level, their support elements have an appropriate common spacing. Before the next plate is deposited on the uppermost level, this spacing is reduced by control unit 14 such that the plate drops down to the middle deposition level. Subsequently, it drops to the lowest level, and the plate from the highest level drops down to the middle level. This is how the buffer is files and the highest level is available again for accepting the next plate.

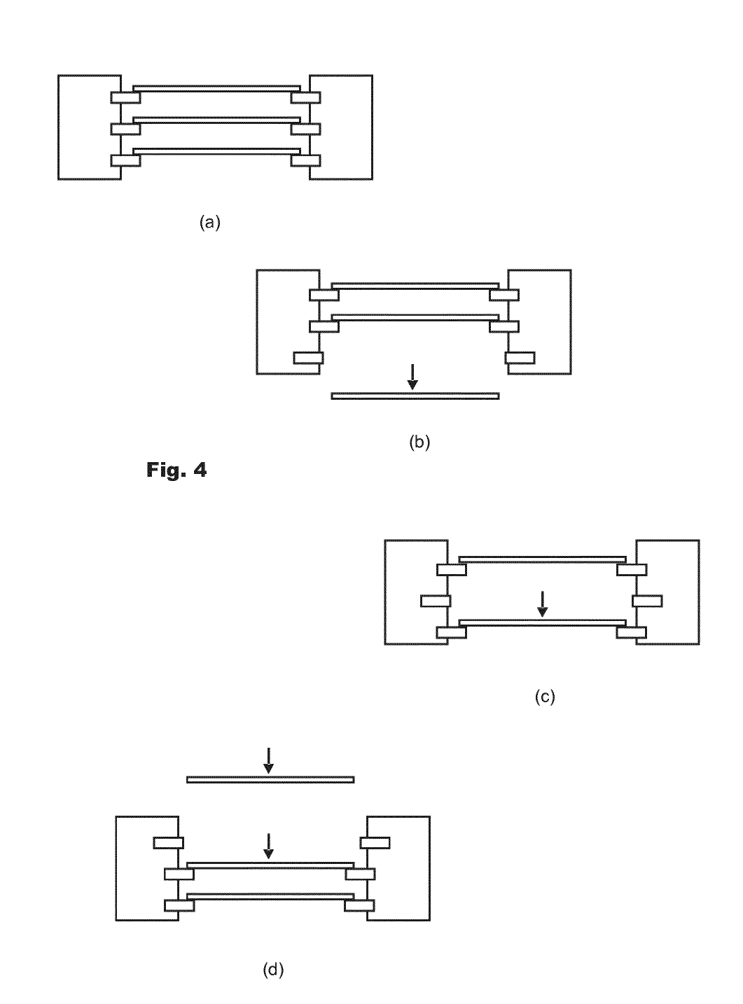

In FIG. 4, letter (a) shows the condition of the filled buffer with three plates at each level. The control unit only controls the buffer such that the lowest plate can drop on the first conveying means (not shown). For this, the interval between opposite control elements is enlarged, as shown in letter (b) of FIG. 4. The timing is such that plates on the first conveying means have a predetermined spacing X between each other. For example, this spacing X has a magnitude of about 5 mm.

As soon as the lowest plate has dropped, the spacing between the support elements of this lowest level is reduced again such that the control unit can control the middle level above and the plate on it will drop down to the lowest level. This process is shown by letter (c). Subsequently, the spacing of the support elements of the middle level is lowered again while the spacing between the support elements of the highest level is enlarged, such that the highest plate can drop down to the middle level (d). Now the highest level is available again for the next plate.

This is how the plates are transported in succession through several steps of the buffer: they drop down through several steps of the buffer by dropping down from one level to another until they finally drop from the lowest deposition level to a conveying means. To dampen the dropping of the plates onto the next lower level, a seal can be applied to the upper side of the support elements. This can be made of an elastomer; in particular polyester urethane rubber has proven practical for this. For example, the product Vulkollan in cellular form can be used. However, any other types of suitable damping material can be applied. Furthermore, the top side of this damping material should preferably be provided with a stable sliding surface to ensure that the damping material is not damaged and that the plates can slide well from the support elements. For example, the sliding surface can be formed by a thin piece of sheet metal or plastic.

The figures show an embodiment of a hot stamping machine 30 in combination with an automatic stamping press. However, the hot stamping machine 30 and the shown transfer arrangement 13 can also be operated with other sources for stamped plates 40. For example, stamped plates can also be stamped in batch mode, then deposited on the second conveyor belt 11 deposited and thus taken to the buffer with the gripper device 50. Plates can also be laid directly from the top to the highest level of the buffer. This can be done manually or with mechanical means, and in both cases, a second conveying means 11 can be done without. Thus, the disclosure is not limited to an embodiment with automatic stamping press and a second conveying means 11, but the inventive transfer arrangement 13 before the conveying means 11 for supplying plates to a hot stamping machine 30 can advantageously also be used under other production circumstances.

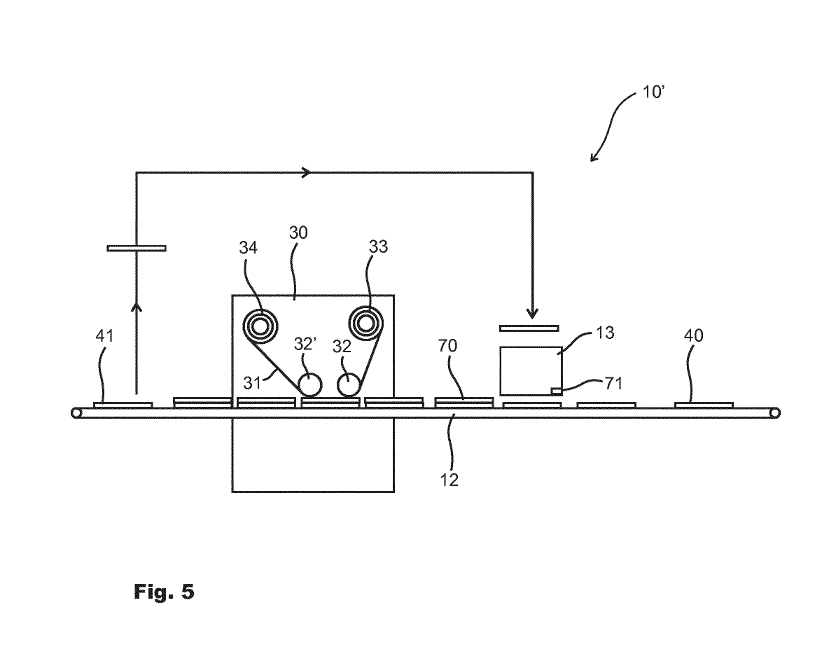

Furthermore, the buffer described for use in the field of motor vehicle license plate manufacturing can also find application in other fields where flat objects must be automatically deposited on a conveying means. For example, FIG. 5 shows a production facility 10′ for such an application where from the buffer of the transfer arrangement 13 templates 70 are in succession placed on license plates 40 which are moved below the buffer on conveyor belt 12 to be moved to a hot stamping machine 30. The hot stamping machine 30 can be designed like the hot stamping machine in the embodiment shown in FIG. 1.

The templates 70 can be flat plates made for example of sheet metal or plastic such as PTFE. In general, the dimensions of the templates correspond to the license plates to be printed. These templates have recesses which leave open those areas where ink is to be applied onto a stamped plate with the hot stamping machine 30.

With this embodiment of the disclosure, the stamped plates 40 can be transported to the hot stamping machine in regular spacings, or the spacings may vary. For a constant and preferably the smallest possible spacing, one of the above described transfer arrangements can be provided before transfer arrangement 13. In that case, the production facility 10′ would thus have two buffers with different functions. With a first buffer, stamped plates could be deposited on a transportation means on which these plates would be laid, and with a second buffer, templates would be laid on those plates. Both buffers could have identical functionalities or different functionalities. However, with templates, too, one buffer with several depositions above each other has proven advantageous.

A sensor means 71 can be provided such that the templates 70 can be deposited at the right time from the buffer of the transfer arrangement 13 to the plates 40 moving below. With this sensor means 71 it can be detected where a plate is located on the transport means 12 or when it is below the transfer arrangement 13 such that a dropping template 70 comes to lie correctly on the plate. For example, the sensor means could be a light barrier.

In that case, too, the templates 70 can be moved to the transportation arrangement in different ways. For example, they can be moved manually or by machine. In particular, it would be advantageous to return used templates from a point behind the hot stamping machine 30 back to the buffer of the transfer arrangement. Such a return is indicated by arrows in FIG. 5. Movable suction grippers or other suitable means can be applied for the return.

1. A production facility for manufacturing motor vehicle license plates, the production facility comprising a hot stamping machine configured for the continuous application of ink to stamped plates by means of hot stamping wherein at least one first conveying means is provided for the transport of stamped plates by the hot stamping machine,
wherein
the production facility comprises at least one transfer arrangement with a buffer with caching means for at least two flat objects, wherein the production facility comprises a control unit configured for controlling the buffer for the deposition of flat objects in succession from the buffer onto the first conveying means.

2. The production facility according to claim 1,
wherein
the flat objects are templates which can be deposited on stamped plates on the first conveying means and which can be transported together with the templates through the hot stamping machine.

3. The production facility according to claim 2,
wherein
the production facility further comprises a sensor means on the first conveying means configured to detect the position of the stamped plates.

4. The production facility according to claim 2,
wherein
the transfer arrangement comprises means to lift templates from printed motor vehicle license plates behind the hot stamping machine and to lead the templates into the buffer of the transfer arrangement.

5. The production facility according to claim 1,
wherein
the flat objects are stamped plates which can be deposited from the buffer onto the conveying means and transported through the hot stamping machine.

6. The production facility according to claim 5,
wherein
the production facility further comprises an automatic stamping press configured for the continuous production of stamped plates and that between the stamping press and the hot stamping machine at least one second conveying means is provided to remove the stamped plates from the stamping press,
and that the transfer arrangement is arranged between the two conveying means wherein the plates stamped with the transfer arrangement can be continuously transferred from the second conveying means to the first conveying means.

7. The production facility according to claim 1,
wherein the control unit is configured to control the buffer such that flat objects from the buffer can be in deposited in succession on the first conveying means with a predetermined spacing between the flat objects.

8. The production facility according to claim 1,
wherein the buffer comprises at least two deposition levels with respective holding means for holding the flat objects at the deposition levels, and that the control unit is configured to control the holding means such that flat objects are held at the respective deposition level or removed from a respective deposition level.

9. The production facility according to claim 8,
wherein the at least two deposition levels are arranged to be above each other.

10. The production facility according to claim 8,
wherein the buffer comprises three deposition levels.

11. The production facility according to claim 8,
wherein each holding means of a deposition level is formed by at least two opposite support elements which are movable by the control unit between at least two positions wherein a flat object is held by the support elements in a first position while the flat object is not held by the support elements in a second position.

12. The production facility according to claim 11,
wherein the spacing between the support elements in a first position is smaller than width B of the flat objects, while the spacing between the support elements in a second position is larger than width B of the flat objects.

13. The production facility according to claim 1,
wherein the first conveying means extends below the buffer.

14. The production facility according to claim 6,
wherein the transfer arrangement comprises a gripper device for transferring plates from the second conveying means into the buffer.

15. The production facility according to claim 14,
wherein the gripper device is a suction gripper.

16. A process for operating a production facility according to claim 1,
wherein flat objects are continuously deposited in succession by the transfer arrangement from the buffer onto the first conveying means.

17. The process according to claim 16,
wherein the license plates are continuously transferred by the transfer arrangement from a second conveying means into the buffer.

18. The process according to claim 16,
wherein the s plates are continuously deposited in succession by the transfer arrangement at a predetermined spacing X onto the first conveying means.

19. The process according to claim 17,
wherein spacing X between the plates on the first conveying means is smaller than spacing Y between den plates on the second conveying means.

20. The process according to claim 18,
wherein spacing X is in the magnitude of 3 mm to 20 mm, in particular between 3 mm and 10 mm, and even more advantageously at about 5 mm.

21. The process according to claim 19,
wherein spacing Y is at least 20 mm.

22. The process according to claim 16,
wherein templates are continuously deposited by the transfer arrangement in succession on stamped plates from the buffer onto the first conveying means.

23. The process according to claim 22,
wherein a template is deposited by the transfer arrangement on a stamped plate onto the first conveying means as soon as a sensor means detects the presence of a stamped plate in a predetermined position on the conveying means.

24. The process according to claim 16,
wherein the control unit controls the buffer of a The production facility such that a flat object drops from a first deposition level whereupon another flat object drops directly from the second deposition level arranged above this first deposition level to the now available first deposition level.

25. The process according to claim 16,
wherein the control unit is in connection with the hot stamping machine and will stop the machine when no flat object is in the buffer.
